(19) United States
(12) Patent Application Publication
(10) Pub. No.: US 2024/0314734 A1
(43) Pub. Date: Sep. 19, 2024

(54) METHOD, DEVICE AND COMPUTER PROGRAM PRODUCT FOR WIRELESS COMMUNICATION

(71) Applicant: ZTE Corporation, Shenzhen (CN)

(72) Inventors: Wei MA, Shenzhen (CN); Hongjun LIU, Shenzhen (CN); Wu WEN, Shenzhen (CN); Dongmei LI, Shenzhen (CN); Li TIAN, Shenzhen (CN)

(21) Appl. No.: 18/610,808

(22) Filed: Mar. 20, 2024

Related U.S. Application Data
(63) Continuation of application No. PCT/CN2022/105282, filed on Jul. 12, 2022.

(51) Int. Cl. H04W 68/02; H04L 1/1812; H04W 72/11; H04W 72/1273; H04W 76/20; H04W 76/30

(52) U.S. Cl. CPC H04W 68/02; H04L 1/1812; H04W 72/11; H04W 72/1273; H04W 76/20; H04W 76/30

(57) ABSTRACT

Method, device and computer program product for wireless communication are provided. A method includes: receiving, by a wireless communication terminal from a wireless communication node, a paging message indicating the wireless communication terminal to receive mobile terminated small data transmission, MT-SDT, data; and receiving, by the wireless communication terminal from the wireless communication node, the MT-SDT data according to the paging message and an MT-SDT configuration.

This Application is a continuation application of International Patent Application No. PCT/CN2022/105282, filed on Jul. 12, 2022 and entitled “Method, Device and Computer Program Product for Wireless Communication,” the entirety of which is hereby incorporated by reference.

This document is directed generally to wireless communications, and in particular to 5^{th} generation (5G) or 6^{th} generation (6G) wireless communication.

In some approaches, the Mobile Originated-SDT (MO-SDT) procedure is used for small data transmission (SDT) for UL (uplink) packets. By allowing transmissions of small and infrequent packets in the RRC (radio resource control) Idle state, the signaling overhead, the power consumption of the UE (user equipment), and the latency of data transmission can be reduced.

The present disclosure relates to methods, devices, and computer program products for mobile terminated small data transmission (MT-SDT).

One aspect of the present disclosure relates to a wireless communication method. In an embodiment, the wireless communication method includes: receiving, by a wireless communication terminal from a wireless communication node, a paging message indicating the wireless communication terminal to receive mobile terminated small data transmission, MT-SDT, data; and receiving, by the wireless communication terminal from the wireless communication node, the MT-SDT data according to the paging message and an MT-SDT configuration.

Another aspect of the present disclosure relates to a wireless communication method. In an embodiment, the wireless communication method includes: transmitting, by a wireless communication node to a wireless communication terminal, a paging message indicating the wireless communication terminal to receive mobile terminated small data transmission, MT-SDT, data; and transmitting, by the wireless communication node to the wireless communication terminal, the MT-SDT data according to an MT-SDT configuration.

Another aspect of the present disclosure relates to a wireless communication terminal. In an embodiment, the wireless communication terminal includes a communication unit and a processor. The processor is configured to: receive, from a wireless communication node, a paging message indicating the wireless communication terminal to receive mobile terminated small data transmission, MT-SDT, data; and receive, from the wireless communication node, the MT-SDT data according to the paging message and an MT-SDT configuration.

Another aspect of the present disclosure relates to a wireless communication node. In an embodiment, the wireless communication node includes a communication unit and a processor. The processor is configured to: transmit, to a wireless communication terminal, a paging message indicating the wireless communication terminal to receive mobile terminated small data transmission, MT-SDT, data; and transmit, to the wireless communication terminal, the MT-SDT data according to an MT-SDT configuration.

Various embodiments may preferably implement the following features:

Preferably, the wireless communication terminal receives the MT-SDT configuration from the wireless communication node.

Preferably, the wireless communication terminal receives the MT-SDT configuration in a first RRC message.

Preferably, the first RRC message comprises an RRC setup message, an RRC reconfiguration message, or an RRC release message.

Preferably, the wireless communication terminal transmits a second RRC message to the wireless communication node to confirm the MT-SDT configuration.

Preferably, the MT-SDT configuration comprises at least one of:
frequency domain resource information;
time domain resource information;
a Configured Scheduling Radio Network Temporary Identifier, CS-RNTI; or
Hybrid Automatic Repeat Request, HARQ, information.

Preferably, the frequency domain resource information comprises Bandwidth Part, BWP, information.

Preferably, the time domain resource information comprises at least one of an offset of a time-domain resource or an allocation of time-domain resource.

Preferably, the HARQ information comprises at least one of a number of configured Hybrid Automatic Repeat Request, HARQ, processes for Semi Persistent Scheduling, SPS or an offset of an HARQ process for SPS.

Preferably, the paging message comprises an MT-SDT indicator indicating the wireless communication terminal to receive MT-SDT data.

Preferably, the MT-SDT indicator comprises an indication on a paging cause with a value for MT-SDT.

Preferably, the wireless communication terminal receives the MT-SDT data on a slot:

(memberOfSlotsPerFrame×SFN+slot number in the frame)=[memberOfSlotsPerFrame×SFN_{start time}+slot_{start time}]modulo(1024×memberOfSlotsPerFrame),
wherein numberOfSlotsPerFrame denotes a number of slots per frame, SFN denotes a system frame number, SFN_{start time} denotes a system frame number of a start time, and slot_{start time} denotes a slot of the start time.

Preferably, the wireless communication terminal receives the MT-SDT data on a symbol:

[(SFN×memberOfSlotsPerFrame×numberOfSymbolsPerSlot)+(slot number in the frame×numberOfSymbolsPerSlot)+symbol number in the slot]=(time ReferenceSFN×memberOfSlotsPerFrame×numberOfSymbolsPerSlot+time DomainOffset×numberOfSymbolsPerSlot+S)modulo(1024×memberOfSlotsPerFrame×numberOfSymbolsPerSlot),
wherein numberOfSlotsPerFrame denotes a number of slots per frame, numberOfSymbolsPerSlot denotes a number of symbols per slot, timeReferenceSFN denotes a time reference system frame number, timeDomainOffset denotes an offset in time domain, and S denotes a start symbol.

Preferably, the wireless communication terminal receives the MT-SDT data on a symbol:

[(SFN×memberOfSlotsPerFrame)+(slot number in the frame×numberOfSymbolsPerSlot)]=(timeReferenceSFN×memberOfSlotsPerFrame+timeDomainOffset+S)modulo (1024×memberOfSlotsPerFrame),
wherein SFN denotes a system frame number, numberOfSlotsPerFrame denotes a number of slots per frame, numberOfSymbolsPerSlot denotes a number of symbols per slot, timeReferenceSFN denotes a time reference system frame number, timeDomainOffset denotes an offset in time domain, and S denotes a start symbol.

Preferably, the wireless communication terminal receives the MT-SDT data on a physical downlink shared channel, PDSCH, according to the MT-SDT configuration.

Preferably, the wireless communication terminal receives the MT-SDT data on a PDSCH without a scheduling from the wireless communication node.

Preferably, the wireless communication terminal receives the MT-SDT data in a Radio Resource Control, RRC, inactive state or an RRC Idle state.

Preferably, the wireless communication node transmits the MT-SDT configuration to the wireless communication terminal.

Preferably, the wireless communication node transmits the MT-SDT configuration in a first RRC message, and the first RRC message comprises an RRC setup message, an RRC reconfiguration message, or an RRC release message.

Preferably, the wireless communication node receives a second RRC message from the wireless communication terminal to confirm the MT-SDT configuration.

Preferably, the wireless communication node transmits the MT-SDT data on a physical downlink shared channel, PDSCH, according to the transmitted MT-SDT configuration.

Preferably, the wireless communication node transmits the MT-SDT data on a PDSCH without a scheduling to the wireless communication terminal.

Preferably, the wireless communication node transmits the MT-SDT data to the wireless communication terminal when the wireless communication terminal is in a Radio Resource Control, RRC, INACTIVE state or an RRC Idle state.

The present disclosure also relates to a computer program product comprising a computer-readable program medium code stored thereupon, the code, when executed by a processor, causing the processor to implement a method for data transmission recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

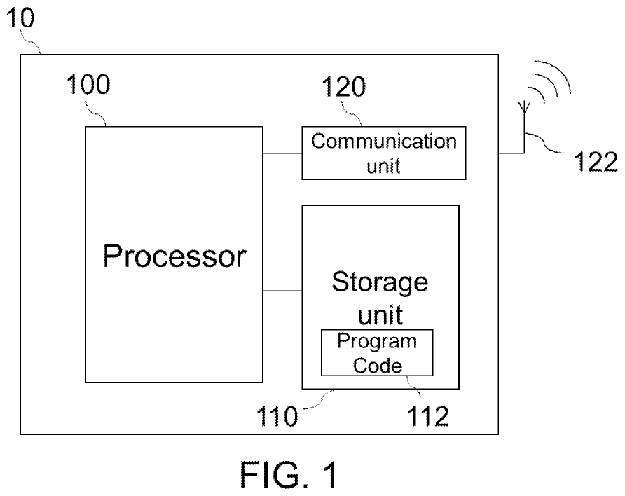

FIG. 1 shows a schematic diagram of a wireless communication terminal according to an embodiment of the present disclosure.

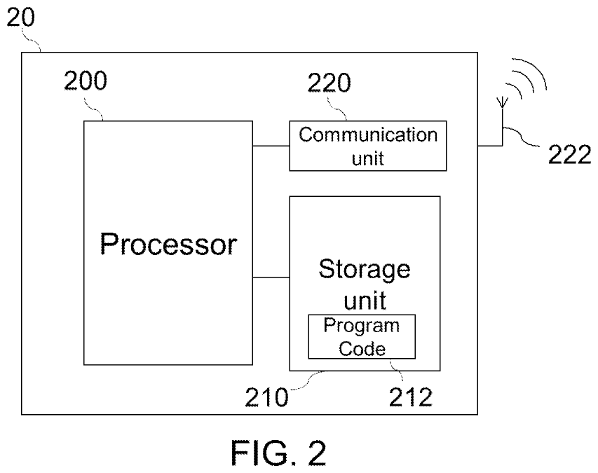

FIG. 2 shows a schematic diagram of a wireless communication node (e.g., a wireless network node) according to an embodiment of the present disclosure.

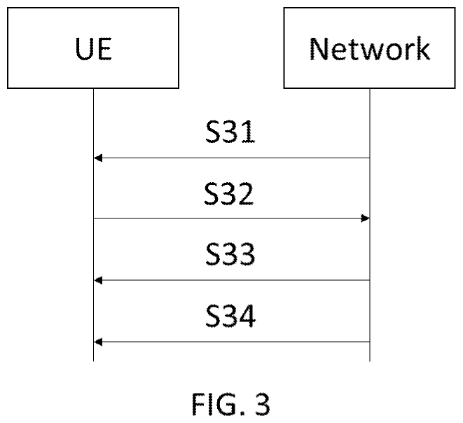

FIG. 3 shows an exemplary procedure MT-SDT according to an embodiment of the present disclosure.

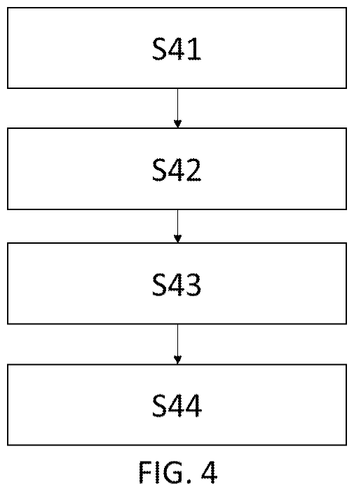

FIG. 4 shows an exemplary procedure for MT-SDT for a UE according to an embodiment of the present disclosure.

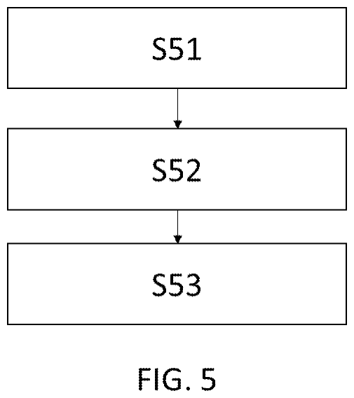

FIG. 5 shows an exemplary procedure for MT-SDT for a network according to an embodiment of the present disclosure.

In some embodiments, the paging message may be used to transmit paging information to a UE in an RRC Idle or RRC INACTIVE state. The network may initiate the paging procedure by transmitting the paging message at the UE's paging occasion. The network may transmit paging information to multiple UEs with a paging message by including one PagingRecord for each UE in the paging message.

However, it is still unclear about the procedure of a mobile terminated SDT (MT-SDT). In particular, it is still unclear about the MT-SDT mechanism for UEs in the RRC_INACTIVE state, which is able to support Random Access based SDT (RA-SDT) and Configured Grant (CG-SDT) as the UL response, and it is also unclear about the MT-SDT procedure for an initial DL data reception and subsequent UL and/or DL data transmissions in the RRC_INACTIVE state.

FIG. 1 relates to a schematic diagram of a wireless communication terminal 10 according to an embodiment of the present disclosure. The wireless terminal 10 may be a user equipment (UE), a mobile phone, a laptop, a tablet computer, an electronic book or a portable computer system and is not limited herein. The wireless terminal 10 may include a processor 100 such as a microprocessor or Application Specific Integrated Circuit (ASIC), a storage unit 110 and a communication unit 120. The storage unit 110 may be any data storage device that stores a program code 112, which is accessed and executed by the processor 100. Embodiments of the storage unit 112 include but are not limited to a subscriber identity module (SIM), read-only memory (ROM), flash memory, random-access memory (RAM), hard-disk, and optical data storage device. The communication unit 120 may a transceiver and is used to transmit and receive signals (e.g., messages or packets) according to processing results of the processor 100. In an embodiment, the communication unit 120 transmits and receives the signals via at least one antenna 122 shown in FIG. 1.

In an embodiment, the storage unit 110 and the program code 112 may be omitted and the processor 100 may include a storage unit with stored program code.

The processor 100 may implement any one of the steps in exemplified embodiments on the wireless terminal 10, e.g., by executing the program code 112.

The communication unit 120 may be a transceiver. The communication unit 120 may as an alternative or in addition be combining a transmitting unit and a receiving unit configured to transmit and to receive, respectively, signals to and from a wireless network node (e.g., a base station).

FIG. 2 relates to a schematic diagram of a wireless network node (e.g., a wireless communication node, a network node, or a network) 20 according to an embodiment of the present disclosure. The wireless network node 20 may be a satellite, a base station (BS), a smart node, a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 20 may comprise (perform) at least one network function such as an access and mobility management function (AMF), a session management function (SMF), a user place function (UPF), a policy control function (PCF), an application function (AF), etc. The wireless network node 20 may include a processor 200 such as a microprocessor or ASIC, a storage unit 210 and a communication unit 220. The storage unit 210 may be any data storage device that stores a program code 212, which is accessed and executed by the processor 200. Examples of the storage unit 212 include but are not limited to a SIM, ROM, flash memory, RAM, hard-disk, and optical data storage device. The communication unit 220 may be a transceiver and is used to transmit and receive signals (e.g., messages or packets) according to processing results of the processor 200. In an example, the communication unit 220 transmits and receives the signals via at least one antenna 222 shown in FIG. 2.

In an embodiment, the storage unit 210 and the program code 212 may be omitted. The processor 200 may include a storage unit with stored program code.

The processor 200 may implement any steps described in exemplified embodiments on the wireless network node 20, e.g., via executing the program code 212.

The communication unit 220 may be a transceiver. The communication unit 220 may as an alternative or in addition be combining a transmitting unit and a receiving unit configured to transmit and to receive, respectively, signals to and from a wireless terminal (e.g., a user equipment or another wireless network node).

In an embodiment, the wireless network node 20 can be the network described below.

Many aspects of the present disclosure are described below, but the present disclosure is not limited to these aspects.

### Aspect 1: Procedure of MT-SDT

In an embodiment, an exemplary procedure for MT-SDT is provided according to an embodiment of the present disclosure as shown in FIG. 3.

In step S31: the network sends an RRC message1 to the UE to configure the MT-SDT resource (e.g., the DL MT-SDT resource). The RRC message1 can be an RRC Setup message, an RRC reconfiguration message, or an RRC release message.

In an embodiment, the RRC message1 includes an MD-SDT configuration. In an embodiment, the UE may receive the MT-SDT data according to the MD-SDT configuration. In an embodiment, the MD-SDT configuration may include: information which indicates the UE to receive the MT-SDT data in the downlink assignment occurring in a slot. In an embodiment, the MD-SDT configuration may include information which indicates the UE to receive the MT-SDT in a specified BWP.

In step S32 (this is an optional step): if the RRC message1 is an RRC Setup message or an RRC reconfiguration message, the UE sends an RRC message2 to the network to confirm the MT-SDT configuration. In an embodiment, if the RRC message1 is RRC release message, the step S32 may be omitted.

In step S33: the network wants to send MT-SDT data to the UE. The network may send a paging message to the UE to inform the UE to receive the MT-SDT data according to the MT-SDT configuration received in the RRC message1 in step S31. The paging message includes an MT-SDT indicator, which indicates that the paging message is notifying the UE to receive the MT-SDT data. The MT-SDT indicator may be a paging cause with a value for MT-SDT.

In step S34: the network transmits the MT-SDT data to the UE according to the MT-SDT configuration (e.g., according to the MT-SDT resource). In an embodiment, the network transmits the MT-SDT data to the UE using the MT-SDT resource configured by RRC message1 (e.g., by the MT-SDT configuration) in step S31. In an embodiment, the UE monitors the DL MT-SDT resource according to the MT-SDT configuration in RRC message1 and receives the MT-SDT data.

### Aspect 2: Procedure of MT-SDT for UE

In an embodiment, an exemplary procedure for the UE for MT-SDT is provided according to an embodiment of the present disclosure as shown in FIG. 4.

In step S41: the UE receives an RRC message1 with an MT-SDT configuration. The MT-SDT configuration may include at least one of:
frequency domain resource information;
time domain resource information;
a Configured Scheduling Radio Network Temporary Identifier (CS-RNTI); and/or
Hybrid Automatic Repeat Request (HARQ) information.

In an embodiment, the frequency domain resource information comprises Bandwidth Part (BWP) information. In an embodiment, the resource for the MT-SDT data includes one or more BWPs.

In an embodiment, the CS-RNTI is for activation, deactivation, and retransmission.

In an embodiment, the HARQ information comprises at least one of: a number of configured HARQ processes for Semi Persistent Scheduling (SPS) and/or an offset of an HARQ process for SPS.

In an embodiment, the time domain resource information comprises at least one of an offset of a time-domain resource and/or an allocation of time-domain resource. In an embodiment, the offset of the time-domain resource may be an offset of a resource with respect to the SFN (e.g., thetimeReferenceSFN) in time domain. In an embodiment, the allocation of time-domain resource may be an allocation of the configured uplink grant in time domain which contains a parameter of startSymbolAndLength or startSymbol.

In step S42: the UE stores the MT-SDT configuration.

In step S43: the UE receives the paging message with an MT-SDT indicator from the network. The indicator triggers the UE to receive the MT-SDT data from the network.

In step S44: the UE receives the MT-SDT data according to the MT-SDT configuration. For example, the UE may:
Receive the MT-SDT data in the one or more BWPs according to the MT-SDT configuration;
Receive the MT-SDT data on the slot/frame/subframe/symbol (time domain source) according to the MT-SDT configuration;
Receive the MT-SDT data on the slot:

(memberOfSlotsPerFrame×SFN+slot number in the frame)=[memberOfSlotsPerFrame×SFN_{start time}+slot_{start time}]modulo(1024×memberOfSlotsPerFrame),
wherein numberOfSlotsPerFrame denotes a number of slots per frame, SFN denotes a system frame number, SFN_{start time} denotes a system frame number of a start time, and slot_{start time} denotes a slot of the start time, and SFN_{start time} and slot_{start time} are the SFN and slot, respectively, of the first transmission of PDSCH (physical downlink shared channel) where the configured downlink assignment is (re-)initialized;

or

[(SFN×memberOfSlotsPerFrame)+(slot number in the frame×numberOfSymbolsPerSlot)]=(time ReferenceSFN×memberOfSlotsPerFrame+timeDomainOffset+S)modulo(1024×memberOfSlotsPerFrame),
wherein SFN denotes a system frame number, numberOfSlotsPerFrame denotes a number of slots per frame, numberOfSymbolsPerSlot denotes a number of symbols per slot, timeReferenceSFN denotes a time reference system frame number, timeDomainOffset denotes an offset in time domain, and S denotes a start symbol (e.g., the parameter startSymbol described above);

or
Receive the MT-SDT data on the symbol:

[(SFN×memberOfSlotsPerFrame×numberOfSymbolsPerSlot)+(slot number in the frame×numberOfSymbolsPerSlot)+symbol number in the slot]=(time ReferenceSFN×memberOfSlotsPerFrame×numberOfSymbolsPerSlot+time DomainOffset×numberOfSymbolsPerSlot+S)modulo(1024×memberOfSlotsPerFrame×numberOfSymbolsPerSlot),
wherein numberOfSlotsPerFrame denotes a number of slots per frame, numberOfSymbolsPerSlot denotes a number of symbols per slot, timeReferenceSFN denotes a time reference system frame number, time DomainOffset denotes an offset in time domain, and S denotes a start symbol.

### Aspect 3: Procedure of MT-SDT for Network

In an embodiment, an exemplary procedure for a network is provided according to an embodiment of the present disclosure as shown in FIG. 5.

Step S51: the network determines the MT-SDT resource for the UE, including the frequency domain resource and the time domain resource, and sends the MT-SDT configuration comprises information of the MT-SDT resource to the UE within an RRC message1.

Step S52: when the network wants to send MT-SDT data to the UE, the network sends a paging message to the UE with an MT-SDT indicator to notify the UE to receive the SDT data.

Step S53: the network transmits the MT-SDT data on the configured MT-SDT resource.

### Aspect 4: MT-SDT Configuration

In an embodiment, the MT-SDT configuration may be configured for a Serving Cell per BWP. In an embodiment, the MT-SDT configuration may include information of one or more BWPs. In an embodiment, the MT-SDT data can be transmitted on the one or more BWPs.

In an embodiment, the MT-SDT configuration may include timeDomainAllocation information, where the timeDomainAllocation information defines the time domain resource of the MT-SDT resource.

In an embodiment, the timeDomainAllocation information may include a parameter startSymbolAndLength or startSymbol. Alternatively, the timeDomainAllocation information may include a parameter startSlotAndLength or startSlot.

In an embodiment, the MT-SDT configuration may include a parameter timeDomainOffset, which defines an offset of a time domain resource with respect to SFN (e.g., timeReferenceSFN) in the time domain.

In an embodiment, the MT-SDT configuration may include an identifier, which identifies the UE's MT-SDT transmission.

In an embodiment, the MT-SDT configuration may include HARQ information, for the HARQ operations between the UE and the network.

### Aspect 5: Paging Message

In an embodiment, to inform the UE to receive the MT-SDT data, the network may send a paging message with an MT-SDT indicator to the UE.

In an embodiment, the MT-SDT indicator may include an information element (IE) paging cause with a value for MT-SDT.

In accordance with an embodiment of the present disclosure, a network may configure a downlink resource without dynamic scheduling to a UE by a RRC message, the downlink resource without dynamic scheduling may be used to transmit MT-SDT data to the UE in an RRC INACTIVE state.

In an embodiment, the network may notify the UE to activate the MT-SDT configuration and/or the MT-SDT resource by sending a paging message to UE.

In an embodiment, the network transmits MT-SDT data to the UE according to MT-SDT configuration and/or the MT-SDT resource.

In accordance with an embodiment of the present disclosure, the UE receives an RRC message with the MT-SDT configuration of downlink resource without dynamic scheduling. The downlink resource without dynamic scheduling may be used to transmit MT-SDT data to the UE in the RRC inactive state.

In an embodiment, the UE may receive a paging message with an indicator for MT-SDT.

In an embodiment, the UE may receive the MT-SDT data according to the MT-SDT configuration.

In accordance with an embodiment of the present disclosure, a wireless communication method includes: receiving, by a wireless communication terminal (e.g., a UE) from a wireless communication node (e.g., a network, a network node, or a base station), a paging message indicating the wireless communication terminal to receive mobile terminated small data transmission, MT-SDT, data; and receiving, by the wireless communication terminal from the wireless communication node, the MT-SDT data according to the paging message and an MT-SDT configuration.

In an embodiment, the wireless communication terminal receives the MT-SDT data on a physical downlink shared channel, PDSCH, according to the MT-SDT configuration.

In an embodiment, the wireless communication terminal receives the MT-SDT data on a PDSCH without a scheduling from the wireless communication node.

In an embodiment, the wireless communication terminal receives the MT-SDT data in a Radio Resource Control, RRC, INACTIVE state or an RRC Idle state.

In an embodiment, the paging message comprises an MT-SDT indicator indicating the wireless communication terminal to receive MT-SDT data. In an embodiment, wherein the MT-SDT indicator comprises an indication on a paging cause with a value for MT-SDT.

In accordance with another embodiment of the present disclosure, a wireless communication method includes: transmitting, by a wireless communication node to a wireless communication terminal, a paging message indicating the wireless communication terminal to receive mobile terminated small data transmission, MT-SDT, data; and transmitting, by the wireless communication node to the wireless communication terminal, the MT-SDT data according to an MT-SDT configuration.

In an embodiment, the wireless communication node transmits the MT-SDT data on a physical downlink shared channel, PDSCH, according to the transmitted MT-SDT configuration.

In an embodiment, the wireless communication node transmits the MT-SDT data on a PDSCH without a scheduling to the wireless communication terminal.

In an embodiment, the wireless communication node transmits the MT-SDT data to the wireless communication terminal when the wireless communication terminal is in a Radio Resource Control, RRC, INACTIVE state or an RRC Idle state.

Details of these wireless communication methods can be ascertained by referring to the embodiments above.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1-30. (canceled)

31. A wireless communication method comprising:
receiving, by a wireless communication terminal from a wireless communication node, a paging message indicating the wireless communication terminal to receive mobile terminated small data transmission, MT-SDT, data; and
receiving, by the wireless communication terminal from the wireless communication node, the MT-SDT data according to the paging message and an MT-SDT configuration.

32. The wireless communication method of claim 31, wherein the wireless communication terminal receives the MT-SDT configuration from the wireless communication node;
wherein the wireless communication terminal receives the MT-SDT configuration in a first RRC message, and the first RRC message comprises an RRC setup message, an RRC reconfiguration message, or an RRC release message; and
wherein the wireless communication terminal transmits a second RRC message to the wireless communication node to confirm the MT-SDT configuration.

33. The wireless communication method of claim 31, wherein the MT-SDT configuration comprises at least one of:
frequency domain resource information;
time domain resource information;
a Configured Scheduling Radio Network Temporary Identifier, CS-RNTI; or
Hybrid Automatic Repeat Request, HARQ, information.

34. The wireless communication method of claim 33, wherein the frequency domain resource information comprises Bandwidth Part, BWP, information;
the time domain resource information comprises at least one of an offset of a time-domain resource or an allocation of time-domain resource; and
the HARQ information comprises at least one of: a number of configured Hybrid Automatic Repeat Request, HARQ, processes for Semi Persistent Scheduling, SPS or an offset of an HARQ process for SPS.

35. The wireless communication method of claim 31, wherein the paging message comprises an MT-SDT indicator indicating the wireless communication terminal to receive MT-SDT data; and
wherein the MT-SDT indicator comprises an indication on a paging cause with a value for MT-SDT.

36. The wireless communication method of claim 31, wherein the wireless communication terminal receives the MT-SDT data on a slot:
(numberOfSlotsPerFrame×SFN+slot number in the frame)=[numberOfSlotsPerFrame×SFN_{start time}+slot_{start time}] modulo (1024×numberOfSlotsPerFrame),
wherein numberOfSlotsPerFrame denotes a number of slots per frame, SFN denotes a system frame number, SFN_{start time} denotes a system frame number of a start time, and slot_{start time} denotes a slot of the start time.

37. The wireless communication method of claim 31, wherein the wireless communication terminal receives the MT-SDT data on a symbol:
[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+S) modulo (1024×numberOfSlotsPerFrame×numberOfSymbolsPerSlot),
wherein numberOfSlotsPerFrame denotes a number of slots per frame, numberOfSymbolsPerSlot denotes a number of symbols per slot, timeReferenceSFN denotes a time reference system frame number, timeDomainOffset denotes an offset in time domain, and S denotes a start symbol.

38. The wireless communication method of claim 31, wherein the wireless communication terminal receives the MT-SDT data on a symbol:
[(SFN×numberOfSlotsPerFrame)+(slot number in the frame×numberOfSymbolsPerSlot)]=(timeReferenceSFN×numberOfSlotsPerFrame+timeDomainOffset+S) modulo (1024×numberOfSlotsPerFrame),
wherein SFN denotes a system frame number, numberOfSlotsPerFrame denotes a number of slots per frame, numberOfSymbolsPerSlot denotes a number of symbols per slot, timeReferenceSFN denotes a time reference system frame number, timeDomainOffset denotes an offset in time domain, and S denotes a start symbol.

39. The wireless communication method of claim 31, wherein the wireless communication terminal receives the MT-SDT data on a physical downlink shared channel, PDSCH, according to the MT-SDT configuration.

40. The wireless communication method of claim 31, wherein the wireless communication terminal receives the MT-SDT data on a PDSCH without a scheduling from the wireless communication node.

41. The wireless communication method of claim 31, wherein the wireless communication terminal receives the MT-SDT data in a Radio Resource Control, RRC, INACTIVE state or an RRC Idle state.

42. A wireless communication method comprising:
transmitting, by a wireless communication node to a wireless communication terminal, a paging message indicating the wireless communication terminal to receive mobile terminated small data transmission, MT-SDT, data; and
transmitting, by the wireless communication node to the wireless communication terminal, the MT-SDT data according to an MT-SDT configuration.

43. The wireless communication method of claim 42, wherein the wireless communication node transmits the MT-SDT configuration to the wireless communication terminal;
wherein the wireless communication node transmits the MT-SDT configuration in a first RRC message, and the first RRC message comprises an RRC setup message, an RRC reconfiguration message, or an RRC release message; and
wherein the wireless communication node receives a second RRC message from the wireless communication terminal to confirm the MT-SDT configuration.

44. The wireless communication method of claim 42, wherein the MT-SDT configuration comprises at least one of:
frequency domain resource information;
time domain resource information;
a Configured Scheduling Radio Network Temporary Identifier, CS-RNTI; or
Hybrid Automatic Repeat Request, HARQ, information.

45. The wireless communication method of claim 44, wherein the frequency domain resource information comprises Bandwidth Part, BWP, information;
the time domain resource information comprises at least one of an offset of a time-domain resource or an allocation of time-domain resource; and
the HARQ information comprises at least one of a number of configured Hybrid Automatic Repeat Request, HARQ, processes for Semi Persistent Scheduling, SPS or an offset of an HARQ process for SPS.

46. The wireless communication method of claim 42, wherein the paging message comprises an MT-SDT indicator indicating the wireless communication terminal to receive MT-SDT data; and
wherein the MT-SDT indicator comprises an indication on a paging cause with a value for MT-SDT.

47. The wireless communication method of claim 42, wherein the wireless communication node transmits the MT-SDT data on a physical downlink shared channel, PDSCH, according to the transmitted MT-SDT configuration.

48. The wireless communication method of claim 42, wherein the wireless communication node transmits the MT-SDT data on a PDSCH without a scheduling to the wireless communication terminal.

49. The wireless communication method of claim 42, wherein the wireless communication node transmits the MT-SDT data to the wireless communication terminal when the wireless communication terminal is in a Radio Resource Control, RRC, INACTIVE state or an RRC Idle state.

50. A wireless communication terminal, comprising:
a communication unit; and
a processor configured to: receive, from a wireless communication node, a paging message indicating the wireless communication terminal to receive mobile terminated small data transmission, MT-SDT, data; and receive, from the wireless communication node, the MT-SDT data according to the paging message and an MT-SDT configuration.
